(19) United States
(12) Patent Application Publication
(10) Pub. No.: US 2024/0279904 A1
(43) Pub. Date: Aug. 22, 2024

(54) UNDERWATER MILLING SUCTION ROBOT

(71) Applicant: STAR (SHANGHAI) TRANSMISSION ENGINEERING CO., LTD., Shanghai (CN)

(72) Inventor: Yungen WANG, Shanghai (CN)

(73) Assignee: STAR (SHANGHAI) TRANSMISSION ENGINEERING CO., LTD., Shanghai (CN)

(21) Appl. No.: 18/198,182

(22) Filed: May 16, 2023

(30) Foreign Application Priority Data
Feb. 20, 2023 (CN) 2023101391726

(51) Int. Cl. E02F 5/28; E02F 3/88

(52) U.S. Cl. CPC E02F 5/282; E02F 3/885

(57) ABSTRACT

An underwater milling suction robot, and relates to the technical field of milling equipment. The underwater milling suction robot comprises a self-propelled platform. A jacking and slewing mechanism is arranged on a top surface of the self-propelled platform. A powerful milling suction actuator and an obstacle cleaning mechanism are arranged on the outer side of the jacking and slewing mechanism. The underwater milling suction robot also comprises an automatic control system. The self-propelled platform, the jacking and slewing mechanism, the powerful milling suction actuator and the obstacle cleaning mechanism are electrically connected with the automatic control system.

### CROSS-REFERENCE TO RELATED APPLICATION

This application claims foreign priority benefits under 35 U.S.C. § 119(a)-(d) to Chinese Patent Application No. 2023101391726, filed on Feb. 20, 2023, which is hereby incorporated herein by reference in its entirety.

### TECHNICAL FIELD

The present disclosure relates to the technical field of milling equipment, in particular to an underwater milling suction robot.

### BACKGROUND

With deep development of marine resources, in view of the demand of underwater foundation engineering construction of offshore shoals (sea beds) or estuary river beds, especially the underwater construction of rock-based sea (river) beds in coastal or offshore local sea areas, there are great problems. For example, in the construction of projects that conventional dredgers and cutter suction dredgers cannot reach offshore sea areas, the construction difficulty is increased, the construction progress is affected, and then the economic construction of marine fisheries, ports and docks is affected.

### SUMMARY

The present disclosure aims to provide an underwater milling suction robot, and solves the engineering construction problem that conventional dredgers and cutter suction dredgers cannot reach offshore sea areas.

In order to solve the technical problem, the present disclosure adopts the following technical scheme.

An underwater milling suction robot includes a self-propelled platform. A jacking and slewing mechanism is arranged on a top surface of the self-propelled platform. A powerful milling suction actuator and an obstacle cleaning mechanism are arranged on the outer side of the jacking and slewing mechanism. The underwater milling suction robot also includes an automatic control system. The self-propelled platform, the jacking and slewing mechanism, the powerful milling suction actuator and the obstacle cleaning mechanism are electrically connected with the automatic control system.

Further, the self-propelled platform includes an H-shaped chassis frame. A front track frame and a rear track frame are symmetrically arranged on front and rear sides of the H-shaped chassis frame. The front track frame and the rear track frame are respectively driven by a front track frame walking driving part and a rear track frame walking driving part.

Further, the self-propelled platform also includes an auxiliary supporting mechanism. The auxiliary supporting mechanism includes a first fixed boom and a second fixed boom. The first fixed boom and the second fixed boom are arranged between the front track frame and the rear track frame.

Further, the jacking and slewing mechanism includes a chassis slewing mechanism. The chassis slewing mechanism is installed in the middle of a top surface of the H-shaped chassis frame. A top surface of the chassis slewing mechanism is connected with a slewing driving part through a slewing bearing with an internal gear. A front leg oil cylinder and a rear leg oil cylinder are arranged below the chassis slewing mechanism. The front leg oil cylinder and the rear leg oil cylinder are installed on a bottom surface of the H-shaped chassis frame.

Further, a lower part of the slewing driving part is connected with a slewing driving mounting seat. The slewing bearing with an internal gear includes a slewing bearing inner ring and a slewing bearing outer ring. The slewing bearing inner ring is fixedly connected with the chassis slewing mechanism. The slewing bearing outer ring is fixedly connected with the slewing driving mounting seat.

Further, the powerful milling suction actuator includes a left actuator and a right actuator which are symmetrically arranged. The left actuator and the right actuator are both installed on the H-shaped chassis frame. The left actuator includes a left pumping part and a left milling drum. The left pumping part is arranged on the right side of the left milling drum. A left sand suction device is arranged below the left pumping part. The right actuator includes a right pumping part and a right milling drum. The right pumping part is arranged on the left side of the right milling drum. A right sand suction device is arranged below the right pumping part. The left pumping part and the right pumping part are the same in structure. The left pumping part includes a hydraulic motor, a gear box and a mud pump.

Further, the right pumping part, the right milling drum and the H-shaped chassis frame are equal in width. The right pumping part, the right milling drum and the H-shaped chassis frame are in rigid connection. The left pumping part and the left milling drum are fixed together. The left pumping part and the left milling drum are hinged with the H-shaped chassis frame through a left milling drum fixed pin. A left milling suction part adjusting mechanism and a left milling drum adjusting screw are arranged between the left pumping part and the H-shaped chassis frame.

Further, the left milling drum and the right milling drum are respectively driven by bidirectional input, namely, front and rear sides of the left milling drum or the right milling drum are provided with milling drum driving parts. A pick arrangement direction and a rotation direction of the left milling drum or the right milling drum are relatively, bidirectionally and symmetrically arranged. Muck milled by middle picks is directly swept into the left pumping part or the right pumping part to be pumped away. Antisymmetrical picks on both sides of the left milling drum or the right milling drum are arranged to discharge the muck towards both sides of a chassis track.

Further, the obstacle cleaning mechanism includes a left mechanical arm, a right mechanical arm, a front mechanical arm and a rear mechanical arm. The left mechanical arm and the right mechanical arm are symmetrically arranged above the left milling drum and the right milling drum. The front mechanical arm and the rear mechanical arm are symmetrically arranged above the front track frame and the rear track frame.

Further, the automatic control system includes an underwater wireless communication remote control box and an underwater hydraulic valve control box. The underwater wireless communication remote control box and the underwater hydraulic valve control box are installed on the H-shaped chassis frame. The H-shaped chassis frame is also provided with an underwater lighting, monitoring and satellite signal receiving device. The underwater wireless communication remote control box, the underwater hydraulic valve control box and the underwater lighting, monitoring and satellite signal receiving device are all connected with an engineering ship control center through special cables.

Compared with the prior art, the present disclosure has the following beneficial effects:

The underwater milling suction robot is completely hydraulically driven. A hydraulic pump station and a remote control system including a satellite signal data transmission system are installed on an engineering ship. Rock, sand and silt cut by milling drums of the robot are sucked to the engineering ship by a pumping system or further reclaimed to a designated sea (river) area through relay pressurization. An efficient, mobile, flexible and safe construction scheme is developed for an underwater rock-based sea (river) bed near coasts. The robot solves the engineering construction problem that conventional dredgers and cutter suction dredgers cannot reach offshore areas can be solved, and has great significance for the economic construction of marine fisheries, ports and docks.

### BRIEF DESCRIPTION OF THE DRAWINGS

The present disclosure is further described below in combination with the attached figures.

FIG. 1 is a front view of an underwater milling suction robot in the present disclosure;

FIG. 2 is a side view of an underwater milling suction robot in the present disclosure;

FIG. 3 is a top view of an underwater milling suction robot in the present disclosure;

FIG. 4 is a section view of an underwater milling suction robot in the present disclosure;

FIG. 5 is a structural schematic diagram of a jacking and slewing mechanism in the present disclosure;

FIG. 6 is a structural schematic diagram of a powerful milling suction actuator in the present disclosure;

FIG. 7 is a structural schematic diagram of left and right pumping parts in the present disclosure;

FIG. 8 is a structural schematic diagram of left and right milling drums in the present disclosure;

FIG. 9 is an arrangement expanded view of bidirectionally antisymmetrical picks on a milling drum in the present disclosure;

FIG. 10 is a structural schematic diagram of left and right milling drums and vertical offsetting arrangement in the present disclosure; and

FIG. 11 is a structural schematic diagram of left milling suction part vertical offsetting arrangement in the present disclosure.

Reference signs: 1, left mechanical arm; 2, left pumping part; 3, slewing driving part; 4, underwater lighting, monitoring and satellite signal receiving device; 5, central hydraulic joint; 6, right pumping part; 7, right mechanical arm; 8, rear track frame; 9, slewing bearing with an internal gear; 9a, slewing bearing inner ring; 9b, slewing bearing outer ring; 10, front track frame; 11, front leg oil cylinder; 12, underwater wireless communication remote control box; 13, underwater hydraulic valve control box; 14, rear leg oil cylinder; 15, front track frame walking driving part; 16, rear track frame walking driving part; 17, first fixed boom; 18, chassis slewing mechanism; 19, second fixed boom; 20, H-shaped chassis frame; 21, milling drum driving part; 22, left milling drum; 23, right milling drum; 24, slewing driving mounting seat; 25, hydraulic motor; 26, gear box; 27, mud pump; 28, left pick; 28-1, left-right rotating pick; 28-2, left-left rotating pick; 29, right pick; 29-1, right-left rotating pick; 29-2, right-right rotating pick; 30, left sand suction device; 31, right sand suction device; 32, front mechanical arm; 33, rear mechanical arm; 34, left milling suction part adjusting mechanism; 35, left milling drum adjusting screw; and 36, left milling drum fixed pin.

### DETAILED DESCRIPTION

In order to make the technical problem to be solved, the technical scheme and the beneficial effects more clear, the present disclosure is further detailed in combination with the attached figures and the embodiment. It shall be understood that, the embodiments described herein are only intended to illustrate but not to limit the present disclosure.

It needs to be noted that, the terms “first” and “second” are merely intended for a purpose of description, and shall not be understood as an indication or implication of relative importance or implicit indication of the number of indicated technical features. Therefore, a feature limited by “first” or “second” may explicitly or implicitly include one or more features. In the description of the present disclosure, the meaning of “a plurality of” means two or more unless expressly specifically defined otherwise. The meaning of “a number of” means one two or more unless expressly specifically defined otherwise.

In the description of the present disclosure, it needs to be illustrated that the indicative direction or position relations of the terms such as “upper”, “lower”, “front”, “rear”. “left” and “right” are direction or position relations illustrated based on the attached figures, just for facilitating the description of the present disclosure and simplifying the description, but not for indicating or hinting that the indicated device or element must be in a specific direction and is constructed and operated in the specific direction, the terms cannot be understood as the restriction of the present disclosure.

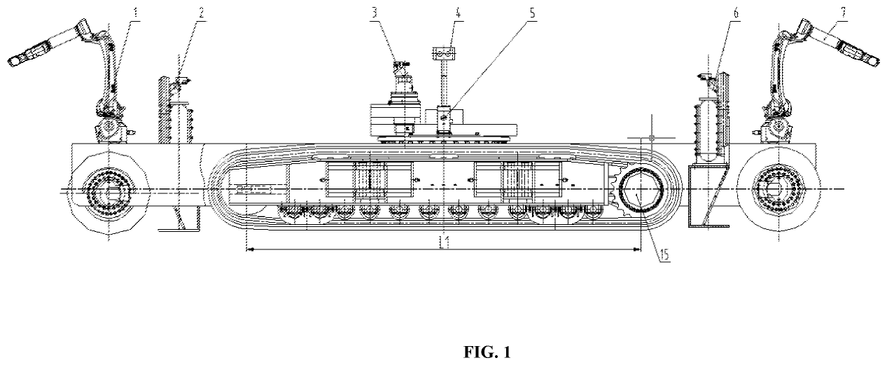

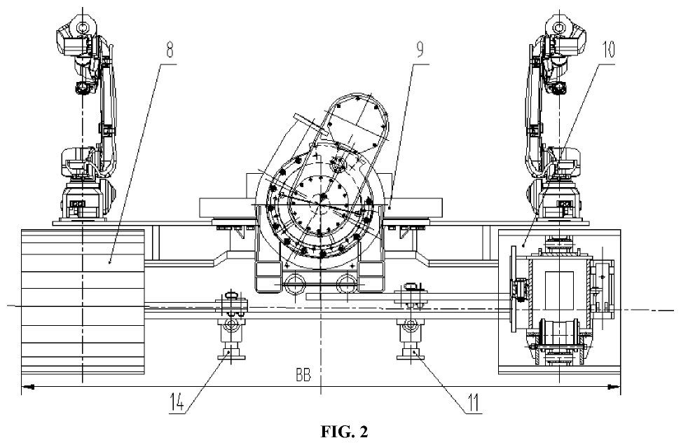

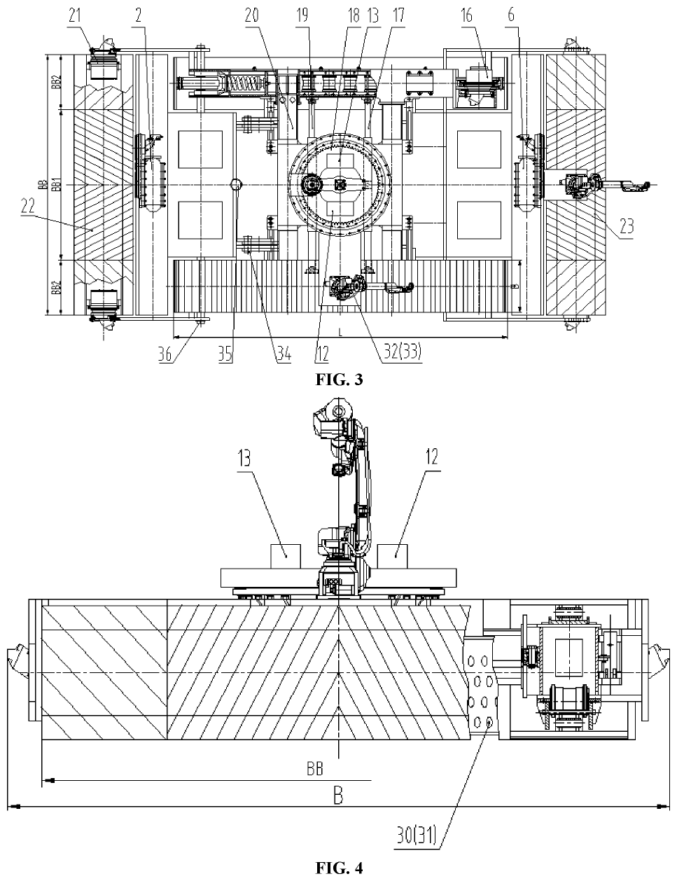

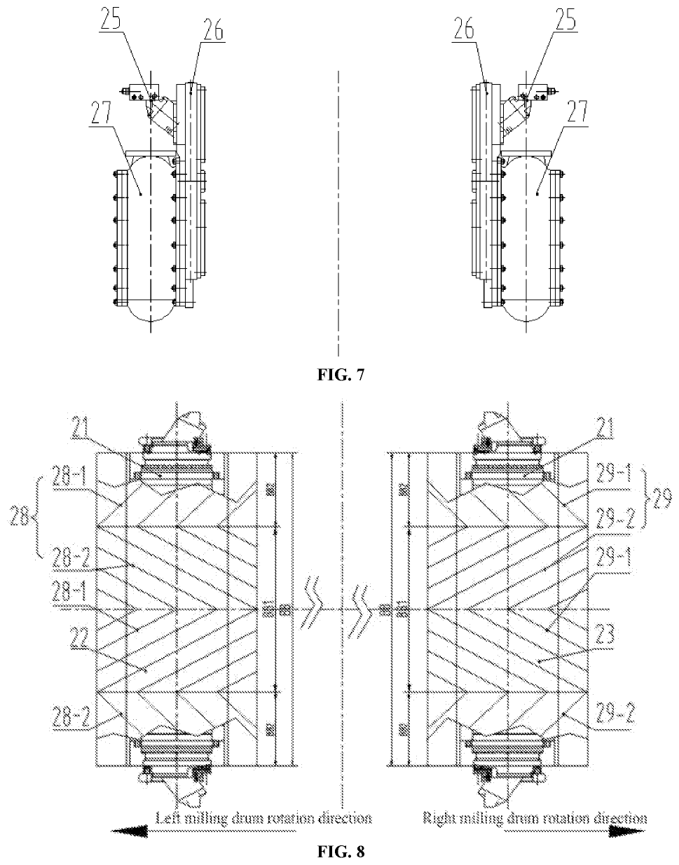

As shown in FIG. 1 to FIG. 11, an underwater milling suction robot includes a self-propelled platform. A jacking and slewing mechanism is arranged on a top surface of the self-propelled platform. A powerful milling suction actuator and an obstacle cleaning mechanism are arranged on the outer side of the jacking and slewing mechanism. The underwater milling suction robot also includes an automatic control system. The self-propelled platform, the jacking and slewing mechanism, the powerful milling suction actuator and the obstacle cleaning mechanism are electrically connected with the automatic control system.

The self-propelled platform includes an H-shaped chassis frame 20. A front track frame 10 and a rear track frame 8 are symmetrically arranged on front and rear sides of the H-shaped chassis frame 20. The front track frame 10 and the rear track frame 8 are respectively driven by a front track frame walking driving part 15 and a rear track frame walking driving part 16. Specifically, track walking driving parts, belonging to conventional driving methods, are composed of a motor (including a control valve), a speed reducer, a driving sprocket and the like. The track walking driving parts are installed on the track frames, and power is input by a hydraulic motor to drive the speed reducer to rotate. The driving sprocket on the speed reducer drives a chain rail to realize track walking. Left and right track frames are respectively driven by independent walking, and can walk synchronously, in a crossed manner or unilaterally to meet the requirements of turning and turning round.

The self-propelled platform also includes an auxiliary supporting mechanism. The auxiliary supporting mechanism includes a first fixed boom 17 and a second fixed boom 19. The first fixed boom 17 and the second fixed boom 19 are arranged between the front track frame 10 and the rear track frame 8. The first fixed boom 17 and the second fixed boom 19 are installed inside the left and right track frames. The rigidity of the equipment is increased to adapt to the harsh working conditions of an uneven sea (river) bed. The first fixed boom 17 and the second fixed boom 19 are also used as supports for placing or fixing other accessories. By adding the first fixed boom 17 and the second fixed boom 19, an auxiliary system with high height difference is arranged to adapt to sea conditions (ocean current impact, sea bed drop and rock cutting load adjustment of underwater milling drums and the like) to a greater extent.

The jacking and slewing mechanism includes a chassis slewing mechanism 18. The chassis slewing mechanism 18 is installed at the middle position of the top surface of the H-shaped chassis frame 20. The top surface of the chassis slewing mechanism 18 is connected with a slewing driving part 3 through a slewing bearing 9 with an internal gear. A front leg oil cylinder 11 and a rear leg oil cylinder 14 are arranged below the chassis slewing mechanism 18. The front leg oil cylinder 11 and the rear leg oil cylinder 14 are installed on a bottom surface of the H-shaped chassis frame 20. Specifically, the slewing driving part 3 is also a conventional driving unit. In the prior art, the slewing driving part 3 consists of a hydraulic motor (including a control valve), a speed reducer and an output gear, and a specific structure of the slewing driving part 3 is not described here.

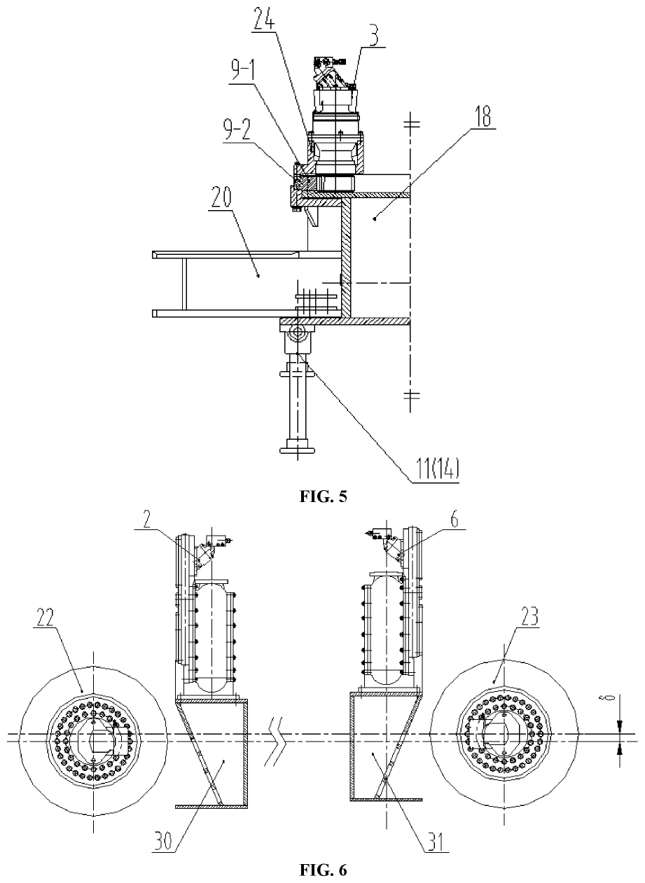

As shown in FIG. 5, a lower part of the slewing driving part 3 is connected with a slewing driving mounting seat 24. The slewing bearing 9 with an internal gear includes a slewing bearing inner ring 9-1 and a slewing bearing outer ring 9-2. The slewing bearing inner ring 9-1 is fixedly connected with the chassis slewing mechanism 18. The slewing bearing outer ring 9-2 is fixedly connected with the slewing driving mounting seat 24.

By setting the jacking and slewing mechanism, the robot has the function of automatically rotating by 0-360 degrees in situ to turn or turning around in situ to change the direction of milling construction operation. The slewing driving part 3 is started. The front leg oil cylinder 11 and the rear leg oil cylinder 14 are opened synchronously. The front leg oil cylinder 11 and the rear leg oil cylinder 14 lift the whole underwater self-propelled robot away from a surface of the sea (river) bed, and then the slewing driving part 3 drives the slewing bearing inner ring 9-1 to rotate. The slewing bearing inner ring 9-1 drives the chassis slewing mechanism 18 to rotate, so that the robot can rotate by 360 degrees in situ and turn or turn around at any angle.

As shown in FIG. 6, the powerful milling suction actuator includes a left actuator and a right actuator which are symmetrically arranged. The left actuator and the right actuator are both installed on the H-shaped chassis frame 20. The left actuator includes a left pumping part 2 and a left milling drum 22. The left pumping part 2 is arranged on the right side of the left milling drum 22. A left sand suction device 30 is arranged below the left pumping part 2. The right actuator includes a right pumping part 6 and a right milling drum 23. The right pumping part 6 is arranged on the left side of the right milling drum 23. A right sand suction device 31 is arranged below the right pumping part 6. The left pumping part 2 and the right pumping part 6 are the same in structure. The left pumping part 2 or the right pumping part 6 includes a hydraulic motor 25, a gear box 26 and a mud pump 27 which are placed on the right side of the left milling drum 22 and the left side of the right milling drum 23 so as to reach the maximum slag suction flow and lift. Driving of the gear box 26 is increase to ensure that the pumping part has enough drive torque to suck slag. The left sand suction device 30 is adjacent to the left milling drum 22. The right sand suction device 31 is adjacent to the right milling drum 23. The left sand suction device 30 and the right sand suction device 31 are responsible for collecting broken sand, sediment and other slag stones cut by the milling drums through the left pumping part 2 and the right pumping part 6, respectively, and transporting the broken sand, sediment and other slag stones to the engineering ship or blowing the broken sand, sediment and other slag stones to a designated sea (river) area through relay pressurization. The whole equipment is symmetrically arranged, and provides convenience for manufacturing, installation, pipeline connection and inspection of parts.

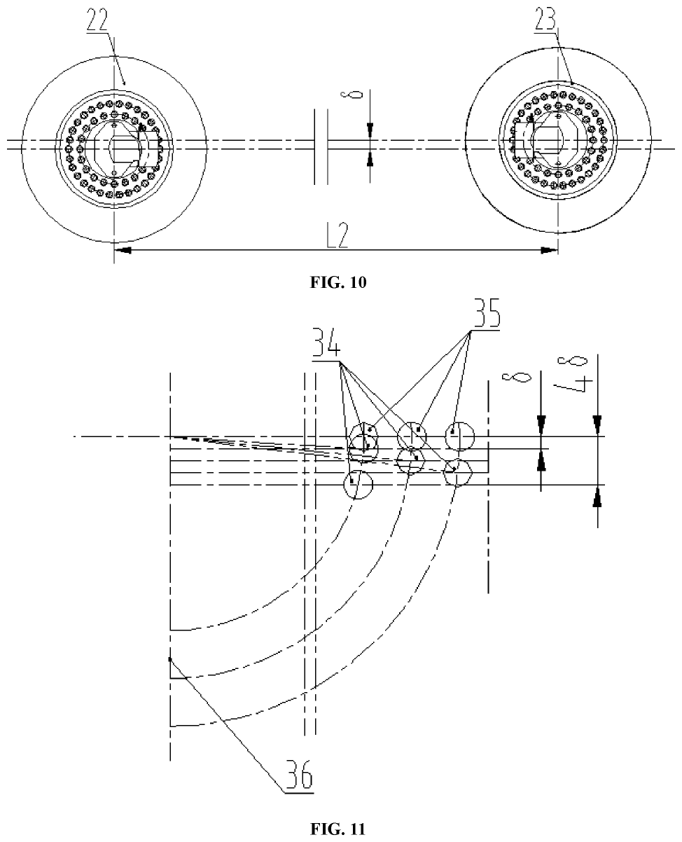

As shown in FIG. 10 and FIG. 11, the right pumping part 6, the right milling drum 23 and the H-shaped chassis frame 20 are equal in width. The right pumping part 6, the right milling drum 23 and the H-shaped chassis frame 20 are in rigid connection. The left pumping part 2 and the left milling drum 22 are fixed together. The left pumping part 2 and the left milling drum 22 are hinged with the H-shaped chassis frame 20 through a left milling drum fixed pin 36. A left milling suction part adjusting mechanism 34 and a left milling drum adjusting screw 35 are arranged between the left pumping part 2 and the H-shaped chassis frame 20. Specifically, the left milling suction part adjusting mechanism 34 is used for adjusting a thickness 8 of rock and soil milled by the left milling drum 22, and four levels of milling thickness, such as 8, 28, 38 and 48, are set for different rock and soil.

Specifically, the left pumping part 2 is fixed on a machine frame through a support. The machine frame extends outward through the outer sides of the left and right track frames and surpasses the outer side of the track (to avoid interference with the track), and then is erected to the outside of the track. Milling drum positioning buckles and fixing mechanisms are designed, processed and installed on the machine frame (paying attention to the rotation of the milling drum outer ring). Mud and sand cut down by the rotation of the milling drums are pumped away through the back pumping part, so the pumping part must be closely arranged with the milling drum. At the same time, the middle position of the pumping part can be designed and fixed with the inner side of the track frame to ensure that the milling drum and the pumping part are installed on the machine frame with sufficient rigidity and strength. At the same time, the whole robot is compact in structure, powerful in function, flexible, simple and reliable in walking and turning operations.

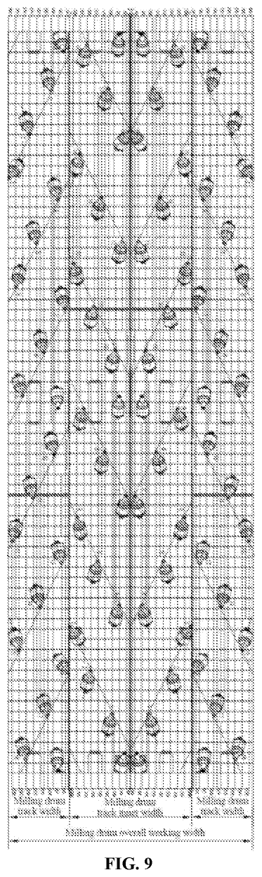

The left milling drum 22 and the right milling drum 23 are respectively driven by bidirectional input, namely, front and rear sides of the left milling drum 22 or the right milling drum 23 are provided with milling drum driving parts 21 so as to powerfully and efficiently cut rock and meet an efficient broking and cutting requirement of intensely weathered granite. A pick arrangement direction and a rotation direction of the left milling drum 22 or the right milling drum 23 are relatively, bidirectionally and symmetrically arranged. Muck milled by middle picks is directly swept into the left pumping part 2 or the right pumping part 6 to be pumped away, and antisymmetrical picks on both sides of the left milling drum 22 or the right milling drum 23 are arranged to discharge the muck towards both sides of a chassis track. Specifically, as shown in FIG. 8, the left milling drum 22 is provided with left picks 28. The left pick includes a left-right rotating pick 28-1 and a left-left rotating pick 28-2 which are arranged at intervals. The right milling drum 23 is provided with right picks 29. The right pick 29 includes a right-left rotating pick 29-1 and a right-right rotating pick 29-2 which are arranged at intervals. An arrangement expanded view of bidirectionally antisymmetrical picks on a milling drum is shown in FIG. 9.

The robot has the following characteristics. Firstly, cutting force generated by the left and right milling drums just counteracts each other for the whole machine, so that the whole machine frame is subjected to the minimum external force load and ensures the highest reliability. Secondly, the milling drums are set for secondary cutting, so that the highest construction efficiency and service life of milling drum picks can be achieved, namely, if the cutting depth is 200 at one time, the cutting load is very large, especially for granite and volcanic rocks with hardness exceeding 100 Mpa, and the damage or consumption of milling drum picks is great. Thus, two-stage cutting is set, namely, in principle, in half. For example, the cutting depth of 200 is changed to 100 for each stage, but the height difference must be artificially set. According to this principle, the structure is uniquely designed. According to different geological conditions (geological exploration reports), the cutting depth of 8 to 48 or even larger before and after adjustment can achieve the highest cutting efficiency and the longest service life of the milling drum, and the cost is reduced. Pin and step-by-step connection are adopted. The site operation is simple, the equipment is safe and reliable, and the requirements of a construction site are met.

The obstacle cleaning mechanism includes a left mechanical arm 1, a right mechanical arm 7, a front mechanical arm 32 and a rear mechanical arm 33. The left mechanical arm 1 and the right mechanical arm 7 are symmetrically arranged above the left milling drum 22 and the right milling drum 23. The front mechanical arm 32 and the rear mechanical arm 33 are symmetrically arranged above the front track frame 10 and the rear track frame 8. The obstacle cleaning mechanism can timely clean large obstacles such as boulders near the operation of the underwater robot or achieve other functions. In the prior art, and a specific structure of the mechanical arm is not described here.

The automatic control system includes an underwater wireless communication remote control box 12 and an underwater hydraulic valve control box 13. The underwater wireless communication remote control box 12 and the underwater hydraulic valve control box 13 have a waterproof function. The underwater wireless communication remote control box 12 and the underwater hydraulic valve control box 13 are installed on the H-shaped chassis frame 20. The H-shaped chassis frame 20 is also provided with an underwater lighting, monitoring and satellite signal receiving device 4. The underwater wireless communication remote control box 12, the underwater hydraulic valve control box 13 and the underwater lighting, monitoring and satellite signal receiving device 4 are all connected with an engineering ship control center through special cables. The underwater lighting, monitoring and satellite signal receiving device 4 can collect topographical and geomorphological three-dimensional data before the construction of the underwater sea (river) bed, and the data are objected in two ways: firstly, the robot is provided with a lighting three-dimensional imaging detection (including monitoring) system to transmit the data to the engineering ship control center in real time through the special cables; and secondly, the data are obtained and transmitted through radars or satellites and a Beidou system.

A central hydraulic joint 5 is also arranged above the chassis slewing mechanism 18. The central hydraulic joint 5 is connected with a hydraulic power source provided by the engineering ship, and is equivalent to a wiring board. A power line comes from the engineering ship, and a socket on the wiring board is a rubber hose joint seat on a rotating joint. The central joint 5 is responsible for providing special hydraulic power for slewing, the milling drums, the mechanical arms and walking which require different flow rates and pressures.

The underwater milling suction robot is completely hydraulically driven. A hydraulic pump station and a remote control system including a satellite signal data transmission system are installed on the engineering ship. Rock, sand and silt cut by milling drums of the robot are sucked to the engineering ship by a pumping system or further reclaimed to a designated sea (river) area through relay pressurization.

The underwater milling suction robot has the following six groups of compound or single actions, and the robot needs to be provided with an underwater on-board control box for accurate control and on-line detection.

The six groups of full hydraulic drive and control actions are specifically as follows.

Firstly, underwater walking.

Secondly, rotating cutting of the milling drums to cut and reclaim a rock-based sea (river) bed.

Secondly, pumping and conveying of slag slurry.

Fourthly, removal of unexpected obstacles through gripping of the mechanical arms or other auxiliary functions.

Fifthly, turning of the robot by the jacking and slewing mechanism or in-situ rotation to turn around or step over the obstacles.

Sixthly, underwater lighting and monitoring adjustment.

The H-shaped chassis frame 20 is provided with the underwater wireless communication remote control box 12 and the underwater hydraulic valve control box 13 with the waterproof function. The underwater wireless communication remote control box 12 and the underwater hydraulic valve control box 13 are used for realizing and controlling all actions of the robot, in which cables and hydraulic hoses are bound and retracted by a winch of the engineering ship.

According to the underwater milling suction robot, an efficient, mobile, flexible and safe construction scheme is developed for an underwater rock-based sea (river) bed near coasts. The robot can solve the engineering construction problem that conventional dredgers and cutter suction dredgers cannot reach the offshore sea area, and has great significance for the economic construction of marine fisheries, ports and docks.

The embodiments described above only describe the preferred manner of the present disclosure and do not limit the scope of the present disclosure, and various modifications and improvements made to the technical solution of the present disclosure by those skilled in the art will fall within the scope of protection as determined by the claims of the present disclosure without departing from the spirit of the design of the present disclosure.

What is claimed is:

1. An underwater milling suction robot, comprising a self-propelled platform, wherein a jacking and slewing mechanism is arranged on a top surface of the self-propelled platform, a powerful milling suction actuator and an obstacle cleaning mechanism are arranged on the outer side of the jacking and slewing mechanism, the underwater milling suction robot also comprises an automatic control system, and the self-propelled platform, the jacking and slewing mechanism, the powerful milling suction actuator and the obstacle cleaning mechanism are electrically connected with the automatic control system.

2. The underwater milling suction robot according to claim 1, wherein the self-propelled platform comprises an H-shaped chassis frame, and a front track frame and a rear track frame are symmetrically arranged on front and rear sides of the H-shaped chassis frame, and the front track frame and the rear track frame are respectively driven by a front track frame walking driving part and a rear track frame walking driving part.

3. The underwater milling suction robot according to claim 2, wherein the self-propelled platform also comprises an auxiliary supporting mechanism, the auxiliary supporting mechanism comprises a first fixed boom and a second fixed boom, and the first fixed boom and the second fixed boom are arranged between the front track frame and the rear track frame.

4. The underwater milling suction robot according to claim 2, wherein the jacking and slewing mechanism comprises a chassis slewing mechanism, the chassis slewing mechanism is installed in the middle of a top surface of the H-shaped chassis frame, a top surface of the chassis slewing mechanism is connected with a slewing driving part through a slewing bearing with an internal gear, a front leg oil cylinder and a rear leg oil cylinder are arranged below the chassis slewing mechanism, and the front leg oil cylinder and the rear leg oil cylinder are installed on a bottom surface of the H-shaped chassis frame.

5. The underwater milling suction robot according to claim 4, wherein a lower part of the slewing driving part is connected with a slewing driving mounting seat, the slewing bearing with an internal gear comprises a slewing bearing inner ring and a slewing bearing outer ring, the slewing bearing inner ring is fixedly connected with the chassis slewing mechanism, and the slewing bearing outer ring is fixedly connected with the slewing driving mounting seat.

6. The underwater milling suction robot according to claim 2, wherein the powerful milling suction actuator comprises a left actuator and a right actuator which are symmetrically arranged, the left actuator and the right actuator are both installed on the H-shaped chassis frame, the left actuator comprises a left pumping part and a left milling drum, the left pumping part is arranged on the right side of the left milling drum, a left sand suction device is arranged below the left pumping part, the right actuator comprises a right pumping part and a right milling drum, the right pumping part is arranged on the left side of the right milling drum, a right sand suction device is arranged below the right pumping part, the left pumping part and the right pumping part are the same in structure, and the left pumping part comprises a hydraulic motor, a gear box and a mud pump.

7. The underwater milling suction robot according to claim 6, wherein the right pumping part, the right milling drum and the H-shaped chassis frame are equal in width, the right pumping part, the right milling drum and the H-shaped chassis frame are in rigid connection, the left pumping part and the left milling drum are fixed together, the left pumping part and the left milling drum are hinged with the H-shaped chassis frame through a left milling drum fixed pin, and a left milling suction part adjusting mechanism and a left milling drum adjusting screw are arranged between the left pumping part and the H-shaped chassis frame.

8. The underwater milling suction robot according to claim 6, wherein the left milling drum and the right milling drum are respectively driven by bidirectional input, namely, front and rear sides of the left milling drum or the right milling drum are provided with milling drum driving parts, a pick arrangement direction and a rotation direction of the left milling drum or the right milling drum are relatively, bidirectionally and symmetrically arranged, muck milled by middle picks is directly swept into the left pumping part or the right pumping part to be pumped away, and antisymmetrical picks on both sides of the left milling drum or the right milling drum are arranged to discharge the muck towards both sides of a chassis track.

9. The underwater milling suction robot according to claim 6, wherein the obstacle cleaning mechanism comprises a left mechanical arm, a right mechanical arm, a front mechanical arm and a rear mechanical arm, the left mechanical arm and the right mechanical arm are symmetrically arranged above the left milling drum and the right milling drum, and the front mechanical arm and the rear mechanical arm are symmetrically arranged above the front track frame and the rear track frame.

10. The underwater milling suction robot according to claim 2, wherein the automatic control system comprises an underwater wireless communication remote control box and an underwater hydraulic valve control box, the underwater wireless communication remote control box and the underwater hydraulic valve control box are installed on the H-shaped chassis frame, the H-shaped chassis frame is also provided with an underwater lighting, monitoring and satellite signal receiving device, the underwater wireless communication remote control box, the underwater hydraulic valve control box and the underwater lighting, monitoring and satellite signal receiving device are all connected with an engineering ship control center through special cables.
